(19) United States
(12) Patent Application Publication
(10) Pub. No.: US 2006/0088174 A1
(43) Pub. Date: Apr. 27, 2006

(54) System and method for optimizing media center audio through microphones embedded in a remote control

(76) Inventors: William C. DeLeeuw, Portland, OR (US); Evan R. Green, (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/975,685

(22) Filed: Oct. 26, 2004

(51) Int. Cl. H04R 3/00; H04R 1/02

(52) U.S. Cl. 381/96; 381/92; 381/91; 381/59

(57) ABSTRACT

A method and system for optimizing media center audio through microphones embedded in a remote control are described. One embodiment of the method involves receiving a command to optimize audio of two or more speakers. Audio data is outputted on the two or more speakers in response to the command. The outputted audio data is collected via a left microphone and a right microphone in the remote control. The collected audio data is analyzed to determine adjustments to the audio data outputted by the two or more speakers in order to optimize the outputted audio data.

### BACKGROUND

Media center systems of today consist of two or more speakers. Many contain 5.1 or even 7.1 multi-speaker systems, where a 5.1 system relates to five speakers and one subwoofer and a 7.1 system relates to seven speakers and one subwoofer. With these multi-speaker systems, the speakers are spread out over a room environment to create a surround sound experience. But often the optimum surround sound experience is limited to an audio sweet spot in the room, if the audio sweet spot exists at all. The audio sweet spot can often be small, perhaps confined to one listener.

For a listener to be in the audio sweet spot of a room environment, usually that listener must be properly positioned between the speakers. Poor positioning of the speakers and/or the listener in the room environment is one factor that can lead to poor balancing of the speakers. Poor balancing of the speakers results in poor sound quality.

Today when a listener wants to move the audio sweet spot around a room environment without moving the physical location of the speakers, the listener may attempt to rebalance the speakers manually. Unfortunately, the rebalancing of speakers is a difficult task to get correct. Here, the listener must manage a complex series of remote control actions, adjusting one speaker's output at a time. It is even worse when the rebalancing functions of the speakers are not available on a remote control. Here, the listener must move from the desired audio sweet spot to adjust the audio settings of each speaker via the front of the media center.

### BRIEF DESCRIPTION OF THE DRAWINGS

The invention may be best understood by referring to the following description and accompanying drawings that are used to illustrate embodiments of the invention. In the drawings:

FIG. 1 illustrates one embodiment of a room environment incorporating an entertainment system and a seating area in which some embodiments of the present invention may operate;

FIG. 2 illustrates one embodiment of a remote control in which some embodiments of the present invention may operate;

FIG. 3 illustrates one embodiment of a media center in which some embodiments of the present invention may operate;

FIG. 4 is a flow diagram of one embodiment of a process for optimizing media center audio through microphones embedded in a remote control;

FIG. 5 is a flow diagram of one embodiment of a process for analyzing digital audio data and comparing it to an optimizing configuration or model for a speaker system of a media center;

FIG. 6 is a flow diagram of one embodiment of a process for rebalancing the speaker system; and

FIG. 7 is a flow diagram of one embodiment of a process for optimizing media center audio through microphones embedded in a remote control while incorporating a user-selected room style.

### DESCRIPTION OF EMBODIMENTS

A method and system for optimizing media center audio through microphones embedded in a remote control are described. In an embodiment, the present invention provides a way for a listener to either create an audio sweet spot or to move the existing audio sweet spot around a seating area of the room environment as the listener moves around the seating area. Also in an embodiment, the present invention embeds microphones in a remote control to listen (and record), much like the human listener, to the audio coming from speakers of the media center. One or more microphones embedded in the left side of the remote control favors the collection of audio data on the left side of the remote control. Likewise, one or more microphones embedded in the right side of the remote control favors the collection of audio data on the right side of the remote control. The remote control then forwards the recorded audio to the media center. The media center analyzes the recorded audio and rebalances its speakers to create a new audio sweet spot in the seating area. This new audio sweet spot is where the remote control was physically located in the seating area when the audio was recorded. In the following description, for purposes of explanation, numerous specific details are set forth. It will be apparent, however, to one skilled in the art that embodiments of the invention can be practiced without these specific details.

Embodiments of the present invention may be implemented in software, firmware, hardware or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and custom hardware components.

Thus, a machine-readable medium may include any mechanism for storing or transmitting information in a form readable by a machine (e.g., a computer). These mechanisms include, but are not limited to, a hard disk, floppy diskettes, optical disks, Compact Disc, Read-Only Memory (CD-ROMs), magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

Some portions of the detailed descriptions that follow are presented in terms of algorithms and symbolic representations of operations on data bits within a computer system's registers or memory. These algorithmic descriptions and representations are the means used by those skilled in the data processing arts to convey the substance of their work to others skilled in the art most effectively. An algorithm is here, and generally, conceived to be a self-consistent sequence of operations leading to a desired result. The operations are those requiring physical manipulations of physical quantities. Usually, although not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

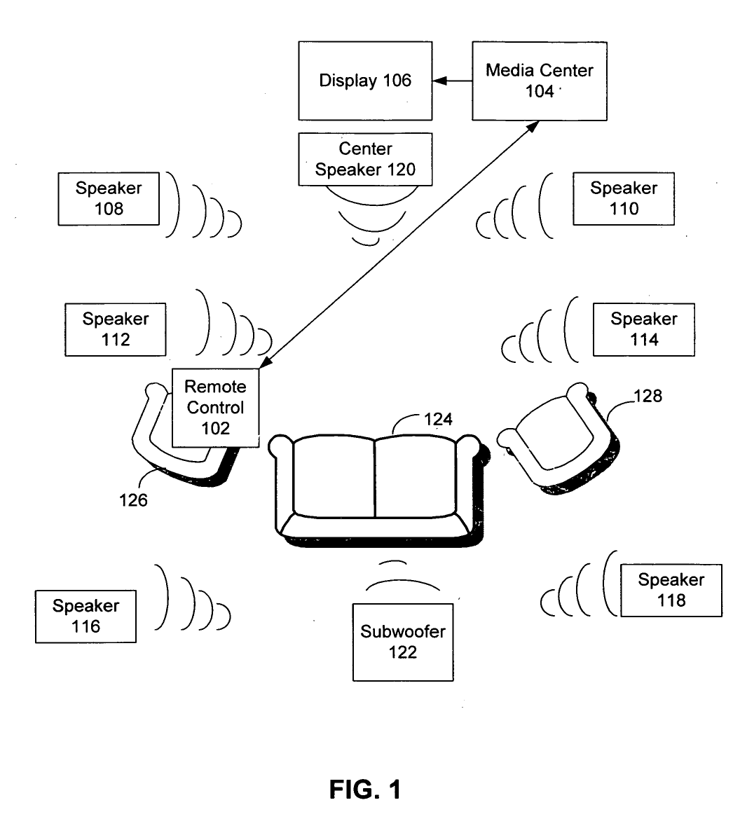

FIG. 1 illustrates one embodiment of a room environment incorporating an entertainment system and a seating area in which some embodiments of the present invention may operate. The entertainment system may include, but is not limited to, a media center and its related components. The seating area may include, but is not limited to, a sofa and several chairs. This room environment is shown as an example of many of the possibilities of an environment for the present invention and is not meant to limit the invention.

Referring to FIG. 1, the entertainment system may include, but is not necessarily limited to, a remote control 102, a media center 104, a display 106, speakers 108-118, center speaker 120 and subwoofer 122. For purposes of the present invention, a listener or user may operate media center 104 with remote control 102 from anywhere in the room environment. Media center 104 sends video output to display 106. Display 106 may be a monitor, projector, a conventional analog television receiver, or any other kind of perceivable video display. Video outputs of media center 104 may also be sent to an external recorder, such as a VTR, PVR, CD or DVD recorder, memory card, etc. Other types of displays and/or devices that receive video outputs of media center 104 may be added or substituted for those described as new types of displays and/or devices that receive video outputs of media center 104 are developed and according to the particular application.

In an embodiment of the invention, speakers 108-118, center speaker 120 and subwoofer 122 are connected to media center 104 and are used to provide a surround sound experience to the room environment of FIG. 1. In an embodiment of the invention, speakers 108-118, center speaker 120 and subwoofer 122 each has its own channel.

In general, with regard to proper positioning of speakers 108-118, center speaker 120 and/or the listener in the room for optimum surround sound, speakers 108-118 are best to be placed at equal distances from the listener with center speaker 120 directly in front of the listener. This is because when the listener is closer to one speaker than the other, the closer speaker will dominate the sound image because its sound arrives earlier and louder at the listener than a speaker further away from the listener. Accordingly, the audio sweet spot is often confined to one listener or location in the room environment. For illustrations purposes only, the audio sweet spot in FIG. 1 may be located in the middle of sofa 124. It is important to note that it may not be possible to create an audio sweet spot via repositioning of speakers in a room environment if, for example, speakers cannot be placed at equal distances from the listener, the center speaker is not directly in front of the listener, there are no speakers behind the listener and/or the back channel speakers favor either the left or right side of the listener.

If we assume that either an audio sweet spot does not exist in the room environment of FIG. 1 or if we assume that the audio sweet spot is located in the middle of sofa 124 (or some other location in the room environment), then what happens if the listener wants to sit on chair 126 and watch a movie via media center 104? As described above, poor positioning of speakers 108-118 and center speaker 120 and/or the listener in the room environment can lead to poor balancing of the speakers. Poor balancing of speakers 108-118 and center speaker 120 results in poor sound quality. The listener sitting in chair 126 is much closer to speakers 108, 112 and 116 than he or she is to speakers 110, 114 and 118. The listener is also not directly in front of center speaker 120. Thus, the listener sitting on chair 126 is not likely to be in the audio sweet spot of the room environment of FIG. 1. Here, the listener may not experience the best sound quality from speakers 108-118 and center speaker 120 because they will sound out of balance to the listener sitting in chair 126.

The present invention provides a way for a listener either to create an audio sweet spot or to move the existing audio sweet spot around the seating area of the room environment as the listener moves around the seating area. The present invention embeds microphones in remote control 102 to listen (and record), much like the human listener, to the audio coming from speakers 108-118 and center speaker 120. One or more microphones embedded in the left side of remote control 102 favors the collection of audio data on the left side of the remote control. Likewise, one or more microphones embedded in the right side of remote control 102 favors the collection of audio data on the right side of the remote control. In an embodiment of the invention, an array of microphones may be embedded inside remote control 102.

Two or more microphones embedded in remote control 102 can better emulate the directional behavior of ears on a human head. In an embodiment of the invention, the use of two or more microphones embedded into remote control 102 allows the present invention to judge direction by determining which direction sound is coming from. This feature aids in creating the audio sweet spot where speakers cannot be placed at equal distances from the listener, the center speaker is not directly in front of the listener and/or there are no speakers behind the listener. For example, the present invention may determine that head related transfer functions are needed to compensate for speakers that are either not physically behind the user or are behind the user but favor either the left or right side. Head related transfer functions provide for the means to take sound that is not coming from behind a person, filter it and reproduce it so that it appears that the sound is coming from behind the person.

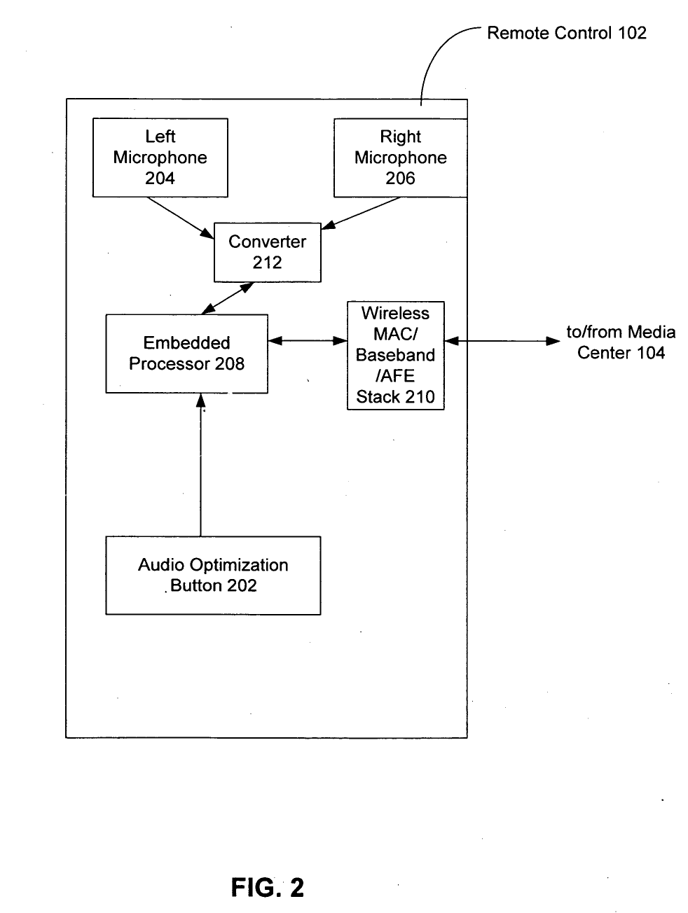

Remote control 102 then forwards the recorded audio to media center 104. Media center 104 analyzes the recorded audio and rebalances speakers 108-118 and center speaker 120 to create a new audio sweet spot in the seating area. This new audio sweet spot is where remote control 102 was physically located in the seating area when the audio was recorded. This process will be described in more detail below with reference to FIGS. 2-7.

In embodiments of the invention, remote control 102, media center 104, display 106, speakers 108-118, center speaker 120 and subwoofer 122 may be able to support communication through analog speaker wire, wide area network (WAN) and local area network (LAN) connections, Bluetooth, Institute of Electrical and Electronics Engineers (IEEE) 802.11, universal serial bus (USB), 1394, intelligent drive electronics (IDE), peripheral component interconnect (PCI), infrared and baseband. Other interfaces may be added or substituted for those described as new interfaces are developed and according to the particular application. The specific devices shown in FIG. 1 represent one example of a configuration that may be suitable for a consumer home entertainment system and is not meant to limit the invention. Remote control 102 is described in more detail next with reference to FIG. 2.

FIG. 2 illustrates one embodiment of remote control 102 in which some embodiments of the present invention may operate. FIG. 2 is used for illustration purposes only and is not meant to limit the invention. The specific components shown in FIG. 2 represent one example of a configuration that may be suitable for the invention and is not meant to limit the invention. Referring to FIG. 2, remote control 102 may include, but is not necessarily limited to, an audio optimization button 202, a left microphone 204, a right microphone 206, an embedded processor 208, a wireless MAC/baseband/AFE stack 210 and an analog to digital converter 212. Though two microphones are shown in FIG. 2, it is understood that any number of microphones may be present in remote control 102. Each of these components is described in more detail next.

Once a user determines his or her desired location in the seating area of the room environment, he or she may press audio optimization button 202 on remote control 102 to optimize the audio of media center 104. Once button 202 is pressed, a command is sent to embedded processor 208. Embedded processor 208 forwards the command to media center 104 via wireless MAC/baseband/AFE stack 210 in one embodiment. In another embodiment, embedded processor 208 forwards the command to media center 104 via infrared, for example. These examples are not meant to limit the invention. In response to this command, media center 104 starts producing audio data. Embedded processor 208 then starts collecting this audio data from left microphone 204 and right microphone 206 via converter 212. Converter 212 operates on analog audio data from microphones 204 and 206 and provides the analog audio data to embedded processor 208.

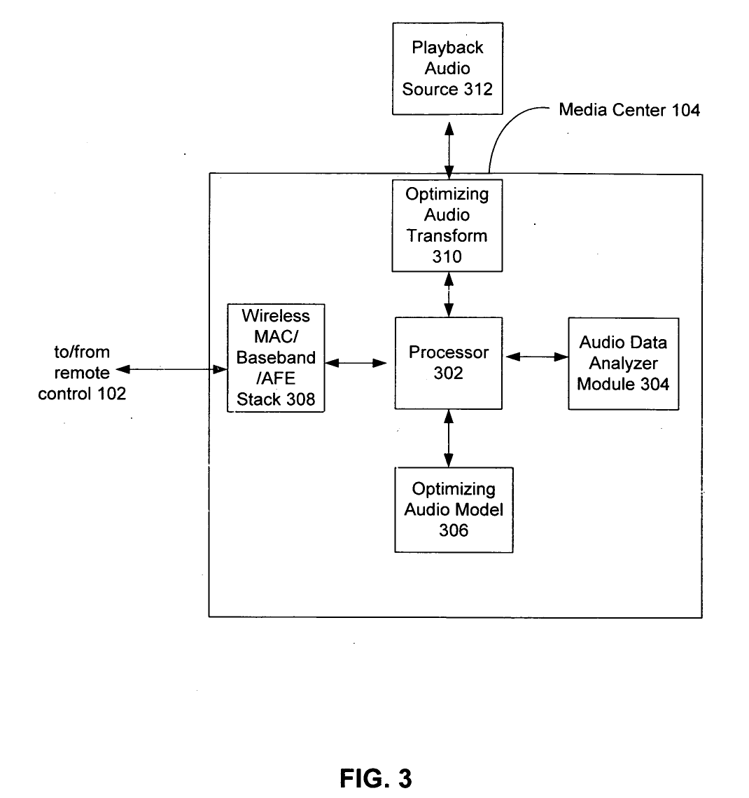

Microphones 204 and 206 are used to sample audio data in one or more directions. Left microphone 204 favors the collection of audio data produced on the left side of remote control 102 (i.e., typically what the user's left ear is hearing). Likewise, right microphone 206 favors the collection of audio data produced on the right side of remote control 102 (i.e., typically what the user's right ear is hearing). In an embodiment of the invention, the collected audio data represents multi-channel audio data. Embedded processor 208 then digitizes the collected audio data via converter 212. Converter 212 is an analog to digital converter that embedded processor 208 may use to digitize the audio data to create digital audio data. In other embodiments of the invention, the functionalities of converter 212 may be incorporated into embedded processor 208. Embedded processor 208 forwards the digitized audio data to media center 104 via wireless MAC/baseband/AFE stack 210. Media center 104 is described in more detail next with reference to FIG. 3.

FIG. 3 illustrates one embodiment of media center 104 in which some embodiments of the present invention may operate. FIG. 3 is used for illustration purposes only and is not meant to limit the invention. The specific components shown in FIG. 3 represent one example of a configuration that may be suitable for the invention and is not meant to limit the invention. Referring to FIG. 3, media center 104 may include, but is not necessarily limited to, a processor 302, an audio data analyzer module 304, an optimizing audio model 306, a wireless MAC/baseband/AFE stack 308 and an optimizing audio transform 310. A playback audio source 312 may be coupled to media center 104. Playback audio source 312 may be used to play back audio that incorporates the optimizing audio transform 310. Playback audio source 312 may be a DVD player, a PVR player, and so forth. These examples are not meant to limit the invention. Each of these components is described next in more detail.

Processor 302 captures, via wireless MAC/baseband/AFE stack 308, the digital audio data and commands forwarded by remote control 102. In an embodiment of the invention, processor 302 is capable of performing multi-channel audio data analysis. In an embodiment of the invention, audio data analyzer module 304 is a software component utilized by processor 302 to perform the multi-channel audio data analysis. Optimizing audio model 306 represents what the digital audio data should sound like to a user positioned within an ideal audio sweet spot. Optimizing audio model 306 may be stored for future use by media center 104.

As described above and in an embodiment, processor 302 along with audio data analyzer module 304 performs multi-channel audio data analysis on the digital audio data collected and forwarded by remote control 102. In embodiments of the invention, part of the analysis performed on the digital audio data may include making adjustments to the digital audio data to ensure that the recorded audio data is more like what the listener is actually hearing. For example, it is likely that the listener was holding remote control 102 approximately two feet in front of him or her when the audio data was recorded. Thus, processor 302 may compensate for the likely physical location of the listener's head in relation to the physical location of remote control 102 when the audio data is recorded by adjusting the digital audio data accordingly. In addition, remote control 102 is typically narrower than the average listener's head. Thus, the average distance between left microphone 204 and right microphone 206 in remote control 102 is not equal to the average distance between the left and right ears of a listener. Again, processor 302 may compensate for the difference in these average distances by adjusting the digital audio data accordingly. Alternatively in other embodiments of the invention, optimizing audio model 306 may be modeled to compensate for the likely physical location of the listener's head in relation to the physical location of remote control 102 and/or the difference between the average distance between left microphone 204 and right microphone 206 in remote control 102 and the average distance between the left and right ears of a listener. These are just examples of how either the digital audio data may be adjusted and/or the optimizing audio model 306 may modeled to better enhance the listening experience for a user. These examples are not meant to limit the invention.

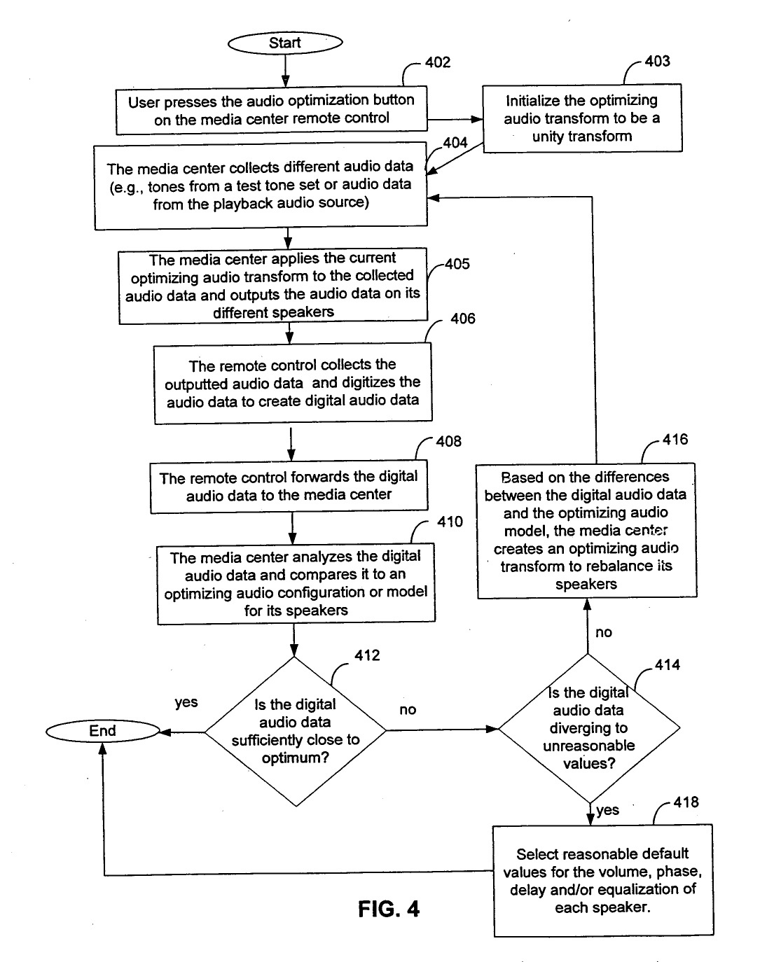

In embodiments of the invention, processor 302 determines via the digital audio data whether objects in the room environment are resonating or vibrating due to certain frequencies in the audio data. Such objects may include, but are not limited to, pictures hanging on a wall and so forth. Processor 302 may make adjustments to frequencies to reduce the resonating of objects in the room environment. Embodiments of the operation of the present invention are described next with reference to FIGS. 4-7.

FIG. 4 is a flow diagram of one embodiment of a process for optimizing media center audio through microphones embedded in a remote control and is not meant to limit the invention. Referring to FIG. 4, the process begins at processing block 402 where the listener or user presses audio optimization button 202 on remote control 102. Optimization button 202 sends the optimization command to embedded processor 208. Embedded processor 208 signals to media center 104, via wireless MAC/baseband/AFE stacks 210 and 308, that the optimization command has been initiated by the user.

At processing block 403, media center 104 initializes an optimizing audio transform to be a unity transform. A unity transform is one that does not actually modify the data. [0037] At processing block 404, media center 104 starts collecting different audio data (tones from a test tone set or audio data from playback audio source 312) in response to the optimization command being initiated by the user. The different data or tones may be produced by an audio test file or test tone set specifically used by the invention to rebalance the media center speakers based on the location of the user. The different data or tones may also be associated with known audio data, for example, known audio data stored on a multi-channel audio source (e.g., a DVD movie soundtrack). In an embodiment of the invention, media center 104 may automatically switch between collecting/outputting the audio test file and known audio data stored on a multi-channel audio source.

At processing block 405, media center 104 applies the current optimizing audio transform to the collected audio data and outputs the audio data on its different speakers. As described above and in an embodiment of the invention, speakers 108-118 and center speaker 120 each has its own channel and thus media center 104 outputs unique data on seven different channels (corresponding to speakers 108-118 and center speaker 120).

At processing block 406, remote control 102 starts collecting or recording the audio data via left microphone 204 and right microphone 206. The collected audio data is forwarded to embedded processor 208. Embedded processor 208 digitizes the audio data to create digital audio data either via converter 310 or similar funcationality built into embedded processor 208.

At processing block 408, embedded processor 208 of remote control 102 forwards the digital audio data to processor 302 of media center 104 via wireless MAC/baseband/AFE stacks 210 and 308. As described above and in some embodiments of the invention, processor 302 may make adjustments to the digital audio data and/or optimizing audio model 306 to compensate for the physical location of remote control 102 in relation to the listener's head when the audio data is being recorded. Processor 302 may also make adjustments to the digital audio data and/or optimizing audio model 306 to compensate for differences in the average distance beween left microphone 204 and right microphone 206 and the user's left and right ears. Processor 302 may also make adjustments to the frequencies in the outputted audio data to reduce the resonating of objects in the room environment.

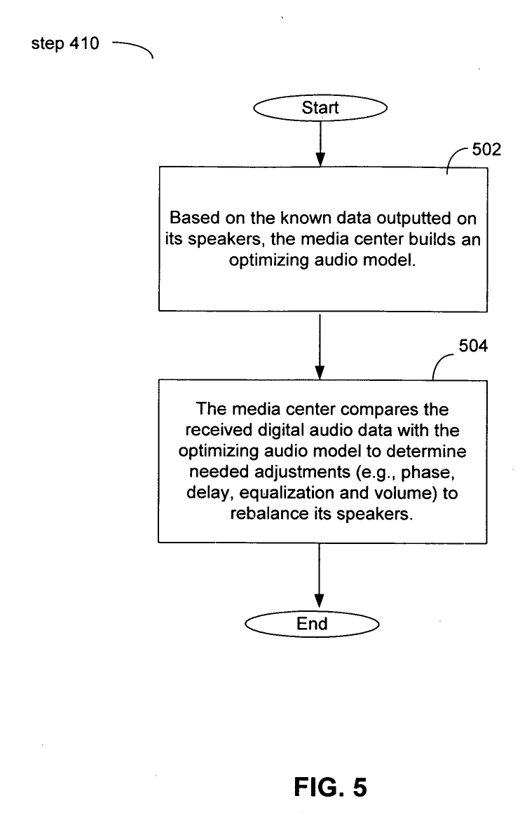

At processing block 410, media center 104 analyzes the digital audio data and compares it to optimizing audio model 306 for its speakers 108-118 and center speaker 120. Here, processor 302 captures, via MAC/baseband/AFE stack 308, the digital audio data from remote control 102. In an embodiment of the invention, processor 302 is capable of performing multi-channel audio analysis. Audio data analyzer module 304 is a software component utilized by processor 302 to perform the multi-channel audio analysis. This analysis is used to create optimizing audio model 306 which represents what the digital audio data should sound like to a user positioned within the audio sweet spot (e.g., speakers 108-118 and center speaker 120 sound balanced to the user). The digital audio data forwarded from remote control 102 (what the user is hearing) is then compared to the optimizing audio model 306 (what the user should be hearing if he or she was in the audio sweet spot) to determine whether the digital audio data is sufficiently close to optimum. As described above, the digital audio data may be modified and/or optimizing audio model 306 may be modeled to compensate for the likely physical location of the listener's head in relation to the physical location of remote control 102 and/or the difference between the average distance between left microphone 204 and right microphone 206 in remote control 102 and the average distance between the left and right ears of a listener. Step 410 is described in more detail below with reference to FIG. 5.

At processing block 412, if media center 104 determined that the digital audio data is sufficiently close to optimum (ie., speakers 108-118 and center speaker 120 are balanced for the user's location), then the process in FIG. 4 ends. Otherwise, the flow control of FIG. 4 goes to processing block 414.

At processing block 414, media center 104 determines whether the digital audio data is diverging to unreasonable values. For example, if remote control 102 was under a pillow when someone accidently pressed audio optimization button 202, then the digital audio data may be diverging to unreasonable values instead of converging closer and closer to optimizing audio model 306. If the digital audio data is diverging, then the process goes to processing block 418 where media center 104 selects reasonable default values for the volumne, phase, delay and/or equalization of speakers 108-118 and center speaker 120. The process in FIG. 4 ends at this point.

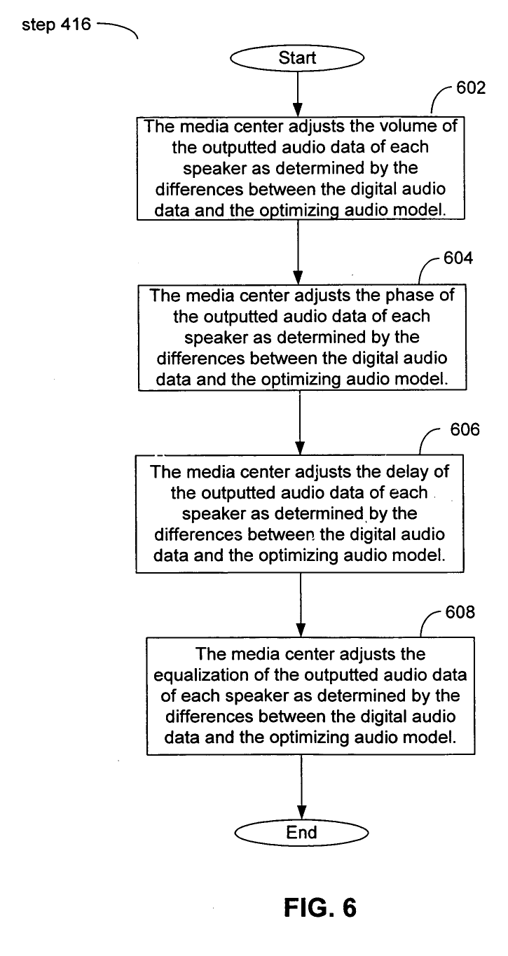

Alternatively, at processing block 416, media center 104 creates an optimizing audio transform 310 to rebalance speakers 108-118 and center speaker 120 based on the differences between the digital audio data (what the user is hearing) and optimizing model 306 (what the user should be hearing if he or she was positioned in the audio sweet spot). The flow control of FIG. 4 returns to step 406. The process of the invention to optimize the audio of media center 104 may be an iterative process. Steps 404 through 416 are repeated until the audio produced by speakers 108-118 and center speaker 120 is sufficiently close to optimum for the user at his or her desired physical location in the seating area (to ensure that the user is in the audio sweet spot) or it is determined that the digital audio data is diverging. Step 416 is described in more detail below with reference to FIG. 6.

In another embodiment, the optimization of media center audio is not initiated by the user via remote control 102. Here, optimization of media center audio may be initiated by media center 104 when known audio data is being outputted on its speakers 108-118 and center speaker 120. Here, media center 104 may take the opportunity to optimize its audio as described in processing blocks 404-414 above. Known audio data may be produced by a multi-channel audio source (e.g., a DVD movie sountrack).

FIG. 5 is a flow diagram of one embodiment of a process for analyzing digital audio data and comparing it to an optimizing configuration or model for a speaker system of a media center (step 410 of FIG. 4). Referring to FIG. 5, the process begins at processing block 502 where media center 104 builds optimizing audio model 306. Optimizing audio model 306 models what the user should be hearing from speakers 108-118 and center speaker 120 if he or she was in the audio sweet spot. Media center 104 knows what the user should be hearing for an optimum experience because it outputs known audio data on speakers 108-120.

As described above, optimizing audio model 306 may be modeled to compensate for the likely physical location of the listener's head in relation to the physical location of remote control 102 and/or the difference between the average distance between left microphone 204 and right microphone 206 in remote control 102 and the average distance between the left and right ears of a listener.

Also as described above, known audio data may be (but is not limited to) specific test data utilized by the present invention or audio data stored on a multi-channel audio source (e.g., a DVD movie soundtrack, etc). In embodiments of the invention, media center 104 may read ahead in the audio data stored on a multi-channel audio source (e.g., DVD) and can build an optimizing model from this data in advance of playing it. This facilitates the invention to react in real time to the user.

At processing block 504, media center 104 compares digital audio data received from remote control 102 with optimizing audio model 306 to determine needed adjustments to the outputted audio data to rebalance its speakers 108-118 and center speaker 120. In an embodiment of the invention, the needed audio data adjustments reflect the difference between the digital audio data and the optimizing audio model 306. These audio data adjustments may include, but are not limited to, volume, phase, delay and equalization. The process in FIG. 5 ends at this point.

FIG. 6 is a flow diagram of one embodiment of a process for rebalancing the speaker system (step 416 of FIG. 4). Referring to FIG. 6, the process begins at processing block 602 where media center 104 adjusts the volume of the outputted audio data of each of speakers 108-118 and center speaker 120 as determined by the differences between the digital audio data and optimizing audio model 306. At processing block 604, media center 104 adjusts the phase of the outputted audio data of each of speakers 108-118 and center speaker 120 as determined by the differences between the digital audio data and optimizing audio model 306. At processing block 606, media center 104 adjusts the delay of the outputted audio data of each of speakers 108-118 and center speaker 120 as determined by the differences between the digital audio data and optimizing audio model 306. At processing block 608, media center 104 adjusts the equalization of the outputted audio data of each of speakers 108-118 and center speaker 120 as determined by the differences between the digital audio data and optimizing audio model 306. It is important to note that steps 602-608 may occur in any order. The process in FIG. 6 ends at this point.

In an alternative embodiment of FIG. 6, one or more of volume, phase, delay and equalization may be modified during any given pass through an optimization iteration. For example, volume may be adjusted through several optimization iterations, followed by modifications of one or more of phase, delay and equalization through one or more optimization iterations, and so forth. In another example, volume may be adjusted through one or more optimization iterations followed by adjustments to delay through one or more optimization iterations, and then followed by adjustments to the volume again through one or more optimization iterations, and so forth. These example is not meant to limit the invention and is used for illustration purposes only.

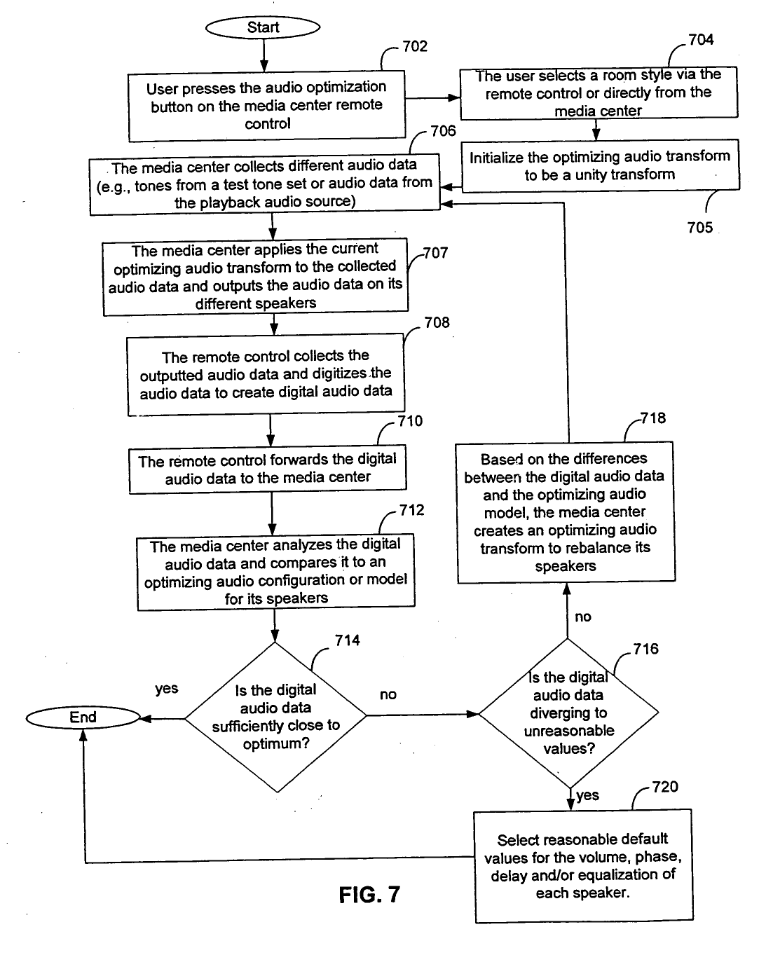

In another embodiment of the invention, the user may select a desired room style via remote control 102 or directly from media center 104 in addition to optimizing the audio for the user's location in the seating area. Room styles include, but are not limited to, live, jazz, opera, and so forth. FIG. 7 is a flow diagram of one embodiment of a process for optimizing media center audio through microphones embedded in a remote control while incorporating a user-selected room style.

Referring to FIG. 7, the process begins at processing block 702 where the user presses audio optimization button 202 on remote control 102. Details of processing block 702 are described above with reference to processing block 402 of FIG. 4.

At processing block 704, the user selects a room style via remote control 102 or directly from media center 104. In an embodiment of the invention, the user may press audio optimization button 202 on remote control 102 after he or she selects a room style via remote control 102.

At processing block 705, media center 104 initializes an optimizing audio transform to be a unity transform.

At processing block 706, media center 104 starts collecting different audio data (e.g. tones from a test tone set or audio data from playback audio source 312) in response to the optimization command being initiated by the user. Details of processing block 706 are described above with reference to processing block 404 of FIG. 4.

At processing block 707, media center 104 applies the current optimizing audio transform to the collected audio data and outputs the audio data on its different speakers.

At processing block 708, remote control 102 starts collecting the audio data via left microphone 204 and right microphone 206. Remote control 102 then digitizes the audio data to create digital audio data. Details of processing block 708 are described above with reference to processing block 406 of FIG. 4.

At processing block 710, remote control 102 forwards the digital audio data and the selected room style to media center 104. Details of processing block 710 are described above with reference to processing block 408 of FIG. 4.

At processing block 712, media center 104 analyzes the digital audio data and compares it to an optimizing configuration or model for speakers 108-118 and center speaker 120. Details of processing block 712 are similar to those described above with reference to processing block 410 of FIG. 4 and FIG. 5. Here, optimizing audio model 306 incorporates not only what the user should be hearing if he or she was in the audio sweet spot, but also audio data representing the room style selected by the user.

At processing block 714, if media center 104 determined that the digital audio data is sufficiently close to optimum (ie., speakers 108-118 and center speaker 120 are balanced for the user's location), then the process in FIG. 7 ends. Otherwise, the flow control of FIG. 7 goes to processing block 716.

At processing block 716, media center 104 determines whether the digital audio data is diverging to unreasonable values (as explained above with reference to step 414 of FIG. 4). If the digital audio data is diverging, then the process goes to processing block 720 where media center 104 selects reasonable default values for the volume, phase, delay and/or equalization of speakers 108-118 and center speaker 120. The process in FIG. 7 ends at this point.

Alternatively, at processing block 718, media center 104 creates an optimizing audio transform 310 to rebalance speakers 108-118 and center speaker 120 based on the differences between the digital audio data (what the user is hearing) and optimizing model 306 (what the user should be hearing if he or she was in the audio sweet spot). Details of processing block 718 are described above with reference to processing block 416 of FIG. 4 and FIG. 6. The flow control of FIG. 7 returns to step 706. The process of the invention to optimize the audio of media center 104 may be an iterative process. Steps 706 through 718 are repeated until the audio produced by speakers 108-118 and center speaker 120 is sufficiently close to optimum for the user at his or her desired physical location in the seating area (to ensure that the user is in the audio sweet spot) or it is determined that the digital audio data is diverging.

A method and system for optimizing media center audio through microphones embedded in a remote control have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method, comprising:
receiving a command to optimize audio of two or more speakers;
outputting audio data on the two or more speakers in response to the command;
collecting the outputted audio data via a left microphone and a right microphone in a remote control;
analyzing the collected audio data to determine adjustments to optimize audio data outputted by the two or more speakers; and
making the determined adjustments to the audio data outputted by the two or more speakers.

2. The method of claim 1, wherein adjustments include at least one of delay, phase, equalization and volume.

3. The method of claim 1, wherein analyzing the collected audio data includes:
building an optimizing audio model; and
comparing the collected audio data with the optimizing audio model to determine the adjustments to the audio data outputted by the two or more speakers to optimize audio data of the two or more speakers.

4. The method of claim 3, wherein the optimizing audio model represents what the collected audio data should sound like if the two or more speakers are balanced.

5. The method of claim 3, wherein the adjustments reflect differences between the collected audio data and the optimizing audio model.

6. The method of claim 3, wherein the optimizing audio model includes audio data related to a room style.

7. The method of claim 3, wherein the room style is selected by a user.

8. The method of claim 1, wherein the command to optimize audio of the two or more speakers is initiated by a user via the remote control.

9. The method of claim 1, wherein the command to optimize audio of the two or more speakers is initiated by a media center.

10. The method of claim 1, wherein the audio data outputted on the two or more speakers is produced by an audio test file.

11. The method of claim 1, wherein the audio data outputted on the two or more speakers is produced by data stored on a multi-channel audio source.

12. The method of claim 11, wherein the multi-channel audio source is a digital versatile disc (DVD) movie soundtrack.

13. The method of claim 1, wherein the audio data outputted on the two or more speakers is produced by either an audio test file or data stored on a multi-channel audio source, and wherein the audio data outputted may switch between the audio test file and the data stored on the multi-channel audio source.

14. The method of claim 1, wherein the audio data outputted on the two or more speakers is produced by data stored on a multi-channel audio source, and wherein the data stored on the multi-channel audio source is read ahead and used to build an optimizing audio model.

15. The method of claim 1, wherein analyzing the collected audio data further includes adjusting the collected audio data to compensate for the physical location of the remote control and a listener in a room environment when the audio data is collected via the left microphone and the right microphone in the remote control.

16. The method of claim 1, wherein analyzing the collected audio data includes adjusting the collected audio data to compensate for the difference between the average distance between the right microphone and the left microphone and the average distance between a right ear and a left ear of a listener.

17. The method of claim 3, wherein analyzing the collected audio data further includes modeling the optimizing audio model to compensate for the physical location of the remote control and a listener in a room environment when the audio data is collected via the left microphone and the right microphone in the remote control.

18. The method of claim 3, wherein analyzing the collected audio data includes modeling the optimizing audio model to compensate for the difference between the average distance between the right microphone and the left microphone and the average distance between a right ear and a left ear of a listener.

19. The method of claim 1, wherein one or more frequencies in the outputted audio data are adjusted to reduce the resonating of one or more objects in a room environment.

20. A system, comprising:
a media center;
two or more speakers coupled to the media center; and
a remote control coupled to the media center, wherein the media center receives a command to optimize audio of two or more speakers, wherein the two or more speakers outputs audio data in response to the command, wherein the remote control collects the outputted audio data via a left microphone and a right microphone, wherein the media center analyzes the collected audio data to determine adjustments to the audio data outputted by the two or more speakers to optimize audio data of the two or more speakers, and wherein the media center makes the determined adjustments to the audio data outputted by the two or more speakers.

21. The system of claim 20, wherein adjustments include at least one of delay, phase, equalization and volume.

22. The system of claim 20, wherein the media center analyzes the collected audio data by building an optimizing audio model and comparing the collected audio data with the optimizing audio model to determine the adjustments to the audio data outputted by the two or more speakers to optimize audio data of the two or more speakers.

23. The system of claim 22, wherein the optimizing audio model represents what the collected audio data should sound like if the two or more speakers are balanced.

24. The system of claim 22, wherein the adjustments reflect differences between the collected audio data and the optimizing audio model.

25. The system of claim 22, wherein the optimizing audio model includes audio data related to a room style.

26. The system of claim 25, wherein the room style is user-selected.

27. The system of claim 20, wherein the command to optimize audio of the two or more speakers is initiated by a user via the remote control.

28. The system of claim 20, wherein the command to optimize audio of the two or more speakers is initiated by a media center.

29. The system of claim 20, wherein the audio data outputted on the two or more speakers is produced by an audio test file.

30. The system of claim 20, wherein the audio data outputted on the two or more speakers is produced by data stored on a multi-channel audio source.

31. The system of claim 30, wherein the multi-channel audio source is a digital versatile disc (DVD) movie soundtrack.

32. The system of claim 20, wherein the audio data outputted on the two or more speakers is produced by either an audio test file or data stored on a multi-channel audio source, and wherein the audio data outputted may switch between the audio test file and the data stored on the multi-channel audio source.

33. The system of claim 20, wherein the audio data outputted on the two or more speakers is produced by data stored on a multi-channel audio source, and wherein the data stored on the multi-channel audio source is read ahead and used to build an optimizing audio model.

34. The system of claim 20, wherein the media center analyzes the collected audio data to adjust the collected audio data to compensate for the physical location of the remote control and a listener in a room environment when the audio data is collected via the left microphone and the right microphone in the remote control.

35. The system of claim 20, wherein the media center analyzes the collected audio data to adjust the collected audio data to compensate for the difference between the average distance between the right microphone and the left microphone and the average distance between a right ear and a left ear of a listener.

36. The system of claim 22, wherein analyzing the collected audio data further includes modeling the optimizing audio model to compensate for the physical location of the remote control and a listener in a room environment when the audio data is collected via the left microphone and the right microphone in the remote control.

37. The system of claim 22, wherein analyzing the collected audio data includes modeling the optimizing audio model to compensate for the difference between the average distance between the right microphone and the left microphone and the average distance between a right ear and a left ear of a listener.

38. The system of claim 20, wherein the media center adjusts one or more frequencies in the outputted audio data to reduce the resonating of one or more objects in a room environment.

39. A machine-readable medium containing instructions which, when executed by a processing system, cause the processing system to perform a method, the method comprising:
receiving a command to optimize audio of two or more speakers;
outputting audio data on the two or more speakers in response to the command;
collecting the outputted audio data via a left microphone and a right microphone in a remote control;
analyzing the collected audio data to determine adjustments to the audio data outputted by the two or more speakers to optimize audio data of the two or more speakers; and
making the determined adjustments to the audio data outputted by the two or more speakers.

40. The machine-readable medium of claim 39, wherein adjustments include at least one of delay, phase, equalization and volume.

41. The machine-readable medium of claim 39, wherein analyzing the collected audio data includes:
building an optimizing audio model; and
comparing the collected audio data with the optimizing audio model to determine the adjustments to the audio data outputted by the two or more speakers.

42. The machine-readable medium of claim 41, wherein the optimizing audio model represents what the collected audio data should sound like if the two or more speakers are balanced.

43. The machine-readable medium of claim 41, wherein the adjustments reflect differences between the collected audio data and the optimizing audio model.

44. The machine-readable medium of claim 41, wherein the optimizing audio model includes audio data related to a room style.

45. The machine-readable medium of claim 41, wherein the room style is selected by a user.

46. The machine-readable medium of claim 39, wherein the command to optimize audio of the two or more speakers is initiated by a user via the remote control.
